(19) United States
(12) Patent Application Publication
(10) Pub. No.: US 2011/0017411 A1
(43) Pub. Date: Jan. 27, 2011

(54) ELECTRIC CURTAIN VIA ACCURATELY CONTROLLING A STOP POSITION OF ITS COVERING SHEET

(75) Inventor: WEI-CHENG YEH, KAOHSIUNG COUNTY 820 (TW)

Correspondence Address: ROSENBERG, KLEIN & LEE, 3458 ELLICOTT CENTER DRIVE-SUITE 101, ELLICOTT CITY, MD, 21043, US

(73) Assignee: BIN TERNG ENTERPRISE CO., LTD., KAOHSIUNG COUNTY 820 (TW)

(21) Appl. No.: 12/507,223

(22) Filed: Jul. 22, 2009

(51) Int. Cl. E06B 9/68

(52) U.S. Cl. 160/310

(57) ABSTRACT

An electric curtain mainly utilizes a covering sheet furled at an upper limit position, which simultaneously impels an actuating member of a zero device to relatively cooperate with a sensor of the zero device, so that the covering sheet would not continue operating and a counter in the zero device would recount once a processing unit of a controlling device receives a signal from the sensor. Thus, the processing unit would drive the counter to recount in every following drop of the covering sheet to accurately control the suspending position without incurring an accumulative counting error and increase an operative convenience.

### BACKGROUND OF THE INVENTION

1. Field of the Invention

The present invention relates to an electric curtain, particular to an electric curtain via accurately controlling a stop position of its covering sheet.

2. Description of the Related Art

Referring to FIG. 1, a conventional electric curtain 1 comprises a rail 10, a rolling shaft 11 pivoted on the rail 10, a power 12 applied to motivate the rolling shaft 11, and a controlling device 13 applied to control the power 12. Wherein, the rolling shaft 11 includes a covering sheet 111 rolled thereon. Moreover, the controlling device 13 includes a turning member 131 synchronizing with the rolling shaft 11, a sensor 132 applied to correspondingly sense the rotation of the turning member 131, a processing unit 133 connected to the sensor 132 to control the power 12, a counter 134 connected to the sensor 132, and a memory unit 135 connected to the processing unit 133.

While in manipulation of the electric curtain 1, users need to set a lower limit position of the covering sheet 111. Namely, when the covering sheet 111 initially descends to the lowest position, the turning member 131 is concurrently triggered to rotate and generate a revolution, whose revolution number is counted and converted into a data by the counter 134. Further, the memory unit 135 saves the data as a standard value, and the raising and descending of the covering sheet 111 would depend on comparing an actual amount counted by the counter 134 with respect to the standard value. Once the number of revolution counted by the counter 134 equals the standard value saved in the memory unit 135, the processing unit 133 would keep the power 12 from running.

After setting up, users draw down the covering sheet 111 again by the power 12 driving the rolling shaft 11, and then the turning member 131 is synchronically rotated for permitting the sensor 132 capable of detecting the rotation thereof and rendering the counter 134 to count the rotation number. Hence, when the number counted by the counter 134 equals to the standard value saved in the memory unit 135, the processing unit 133 prevents the power 12 from running to impede the dropping of the covering sheet 111. Whereas, when the covering sheet 111 is retracted upward, the processing unit 133 would trigger the power 12 to rotate the rolling shaft 11 until the revolution number counted by the counter 134 equals to the standard value saved in the memory unit 135. Therefore, the covering sheet 111 would be retracted to the upper limit position base on above preset standard data.

Obviously, the conventional operating rationale mainly depends on the counting value executed by the counter 134 relative to the standard data saved in the memory unit 135 for lifting and dropping the covering sheet 111, so that the processing unit 133 accordingly determines the timing for stopping the power 12. However, an accumulative imprecision of the counter 134 may be probably generated since a mal-sensing may affect the function of the sensor 132, or a facile transmission inertia between the power 12 and the rolling shaft 11 may incur an inaccurate motion and result errors produced therebetween. Thus, the actual rotating quantity of the turning member 131 would inevitably deviate from the number counted by the counter 134 in a long term of using to cause the electric curtain 1 unable to precisely furl and drop the covering sheet 111 to the desired upper and lower limit positions.

If an electricity outage happens unpredictably, the counter 134 forcedly interrupts the counting and has to restart its counting while resuming the power supply. In such situation, the counter 134 usually confuses the revolution number of furling the covering sheet 111 with the revolution number of lowering the covering sheet 111 and makes an inaccurately counting and even a shutdown of the controlling device 13. Thus, the conventional electric curtain 1 needs to reset the setting, which causes an inconvenient using and requires improvements.

### SUMMARY OF THE INVENTION

Therefore, the object of the present invention is to provide an electric curtain that assists in accurately suspending the covering sheet at a preferable position in each operation and increasing a convenience of using.

The electric curtain in accordance with the present invention mainly provides with a rail, a rolling shaft pivoted on the rail, a power located relative to the rail for driving the rotation of the rolling shaft, a zero device disposed at one side of the power, and a controlling device connected to the zero device and the power. Wherein, the zero device has a turning member concurrently rotated with the rolling shaft, an actuating member disposed correspondingly to the turning member, a sensor correspondingly positioned to the actuating member, and a counter connected to the sensor. Additionally, the controlling device includes a receiver connected to the sensor, a processing unit respectively connected to the receiver and the power, and a memory member connected to the processing unit. When a covering sheet is rolled by the rolling shaft to stop at its upper limit position to trigger the actuating member every time, the sensor would generate a signal and send it to the processing unit, for which to control the counter to resume its counting to zero so as to recount the succeeding descending operation base on a standard value stored in the memory member. Whereby, an accumulative inaccuracy of the counting in a long term of using can be avoided for efficiently stopping the covering sheet at a desired position without further adjustments while using in a long period and increasing a using convenience.

The advantages of the present invention would be apparent in following embodiments with drawings, and like elements are denoted by same numerals throughout the disclosure.

### BRIEF DESCRIPTION OF THE DRAWINGS

FIG. 1 is a perspective view showing a conventional invention;

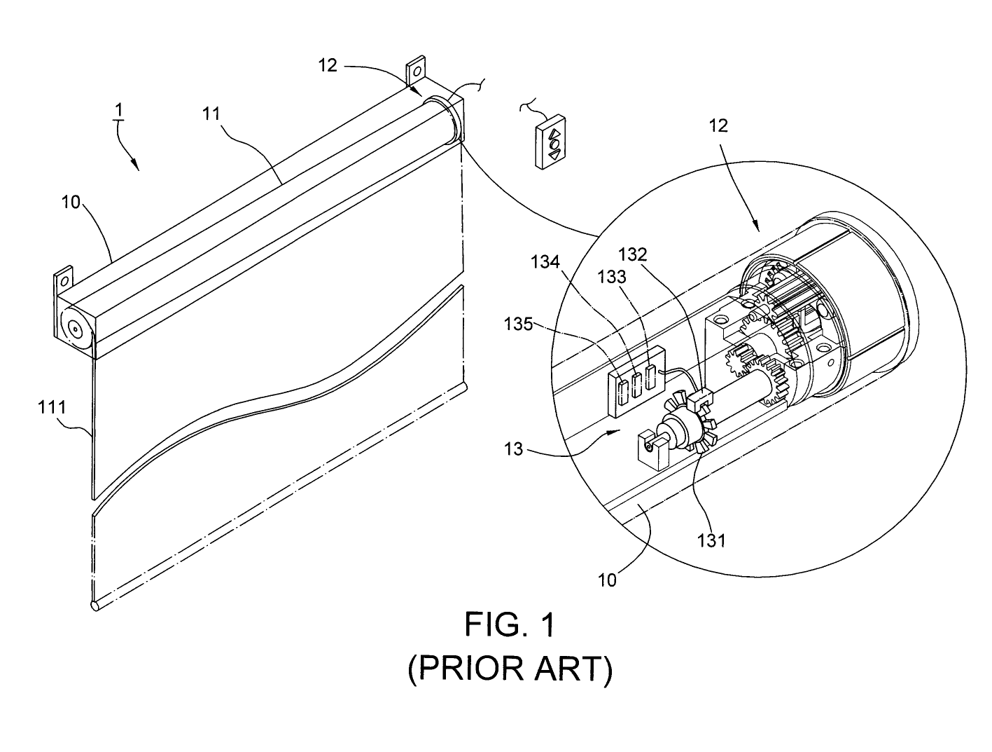

FIG. 2 is a perspective view showing a first preferred embodiment of the present invention;

FIG. 3 is an enlarged view showing partial components of the first embodiment;

FIG. 4 is a schematic view showing the first preferred embodiment while setting and descending;

FIG. 5 is a flow diagram showing the dropping of the first embodiment;

FIG. 6 is another schematic view showing the first preferred embodiment while furling;

FIG. 7 is a flow diagram showing the furling of the first embodiment;

FIG. 8 is a perspective view showing a second preferred embodiment of the present invention; and

FIG. 9 is an enlarged view showing partial components of a third preferred embodiment of the present invention.

### DETAILED DESCRIPTION OF THE PREFERRED EMBODIMENTS

Before in greater detail, it is noted that the like elements are denoted by the similar reference numerals throughout the disclosure.

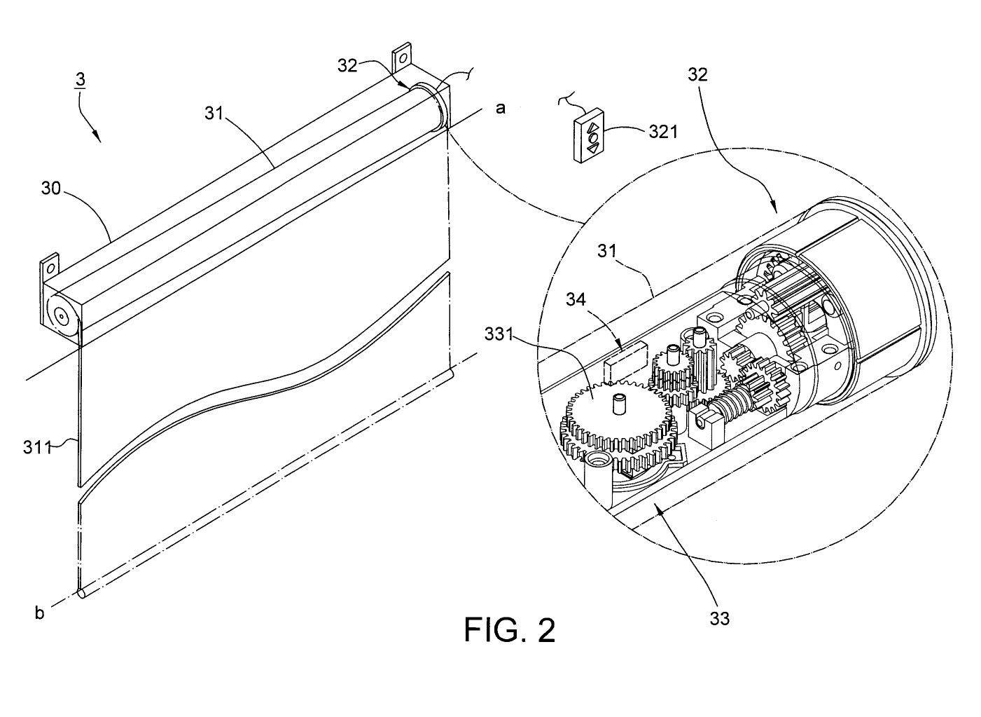

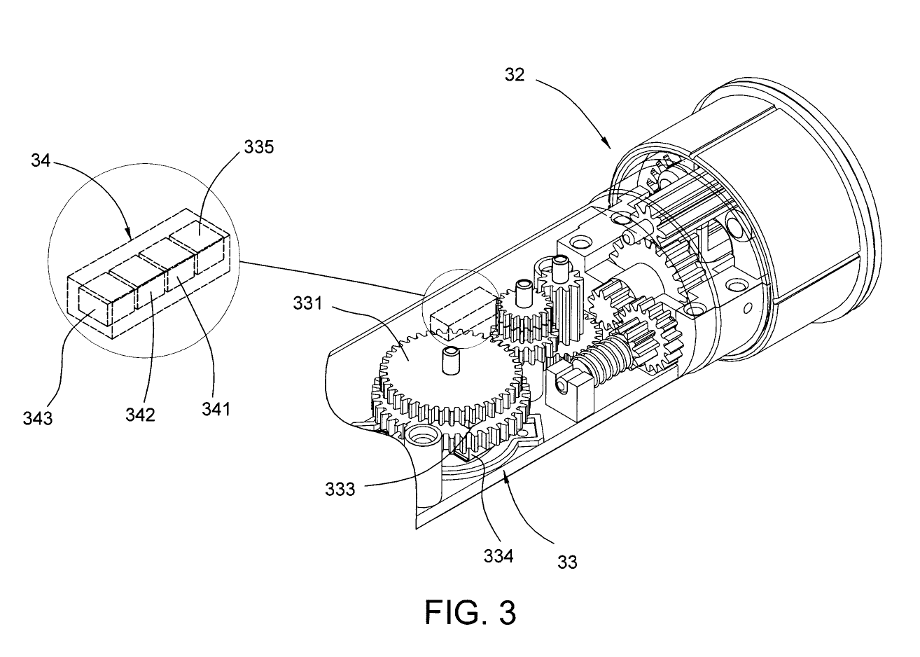

Referring to FIGS. 2 and 3 showing a first preferred embodiment of an electric curtain 3 comprises a rail 30, a rolling shaft 31 pivoted on the rail 30, a power 32 located on the rail 30 for driving the rotation of the rolling shaft 31, a zero device 33 disposed at one side of the power 32, and a controlling device 34 connected to the zero device 33 and the power 32. Wherein, the rolling shaft 31 includes a covering sheet 311 swiveled thereby, and the covering sheet 311 is restricted to stop extremely at an upper limit position a and a lower limit position b. Further, the zero device 33 includes a turning member 331 concurrently rotated with the rolling shaft 31, an actuating member 333 preferably installed on the turning member 331, a sensor 334 positioned correspondingly to the actuating member 333, and a counter 335 connected to the sensor 334. Additionally, the controlling device 34 includes a receiver 341 connected to the sensor 334, a processing unit 342 respectively connected to the receiver 341 and the power 32, and a memory unit 343 connected to the processing unit 342.

Wherein, the power 32 could be triggered by a starter 321 which is directed to a wireless remote control or directed to a wired switch used by pressing. Herein, the starter 321 in the illustration adopts a wireless remote control. Moreover, to promote a preferable matching position of the actuating member 333 with respect to the sensor 334, the actuating member 333 and the sensor 334 are coaxially disposed on an axle as illustrated.

Successively, when the covering sheet 311 is rolled to stop at its upper limit position a, the actuating member 333 on the turning member 331 would concurrently rotate relatively to the sensor 334, from which a signal is emitted for the receiver 341 of the controlling device 34 to receive. Accordingly, when the processing unit 342 receives the signal transmitted by the sensor 334, the processing unit 342 would properly stop the operation of the power 32 and control the counting of the counter 335 turning to zero. Thus, for initially dropping or descending the covering sheet 311, the counter 335 would preset its counting.

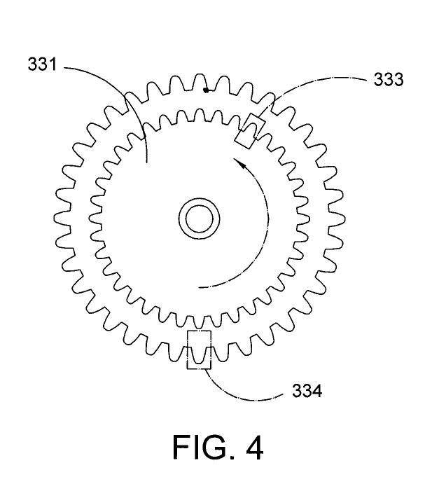

Still referring to FIGS. 2 and 3, before a substantial operation, users need to set a proper lower limit position b of the covering sheet 311. Wherein, the lower limit position b is directed where the covering sheet 311 is dropped to its extreme lowest position. Thereby, when the covering sheet 311 is dropped from the upper limit position a toward its lower limit position b, the turning member 331 would be concurrently rotated with the rolling shaft 31 to motivate the actuating member 333 to deviate from the sensor 334 as shown in FIG. 4. Accordingly, the counter 335 would not only synchronically count the rotating quantity of the actuating member 333 on the turning member 331 detected via the sensor 334 but also concurrently convert the quantity into a data. Whereby, the data would be saved in the memory unit 343 as a standard data basis for the next dropping of the covering sheet 311.

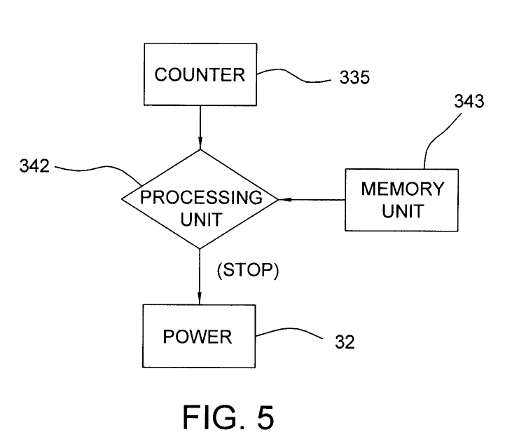

Referring to FIGS. 3, 4, and 5, when users desire to drop the electric curtain 3 again after setting up, they can directly press the starter 321 to trigger the power 32 so as to motivate the rolling shaft 31 for rotably synchronizing the covering sheet 311 with the turning member 331. Thence, the actuating member 333 on the turning member 331 would rotate correspondingly to the sensor 334 as arrowed in FIG. 4. When an actual rotating quantity of the actuating member 333 counted by the counter 335 equals the standard data basis saved in the memory unit 343, the processing unit 342 accordingly controls the power 32 to stop dropping the covering sheet 311.

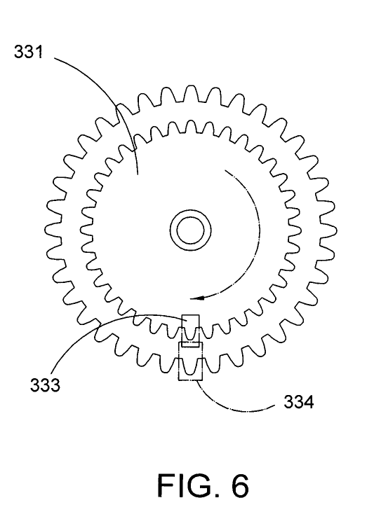

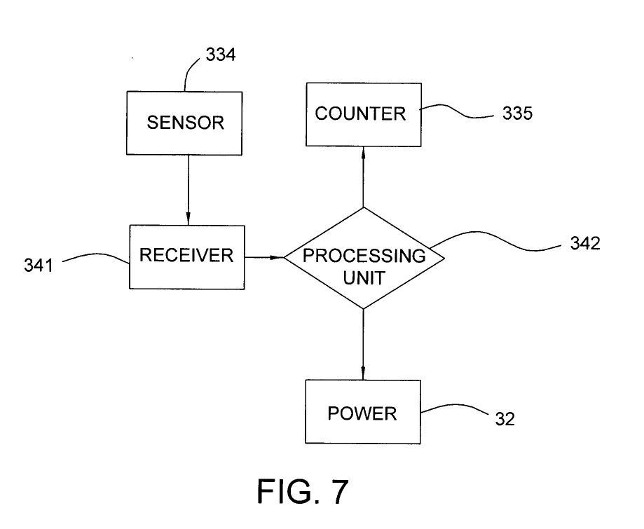

Reciprocally, referring to FIGS. 2, 3, and 6, in furling the covering sheet 311, the power 32 drives the rolling shaft 31 to gradually move the actuating member 333 on the turning member 331 close to the sensor 334 until the actuating member 333 and the sensor 334 are aligned as shown in FIG. 6. Further referring to FIG. 7, the sensor 334 would detect the rotation of the actuating member 333 on the turning member 331 to transmit a signal to the receiver 341 to promote the processing unit 342 for stopping the power 32 from running and simultaneously zeroing the counting of the counter 335. Therefore, the counter 335 would resume its counting every time when the covering sheet 311 is drawn downward, thereby avoiding the mechanical inertia and cumulative errors that causes inexact downward and upward motions of the covering sheet 311 after using for a long period. Whereby, the present invention preferably obtains a precise controlling of the stop position of the covering sheet without frequent adjustments or settings of the covering sheet 311 in a long term of using, thus increasing a using convenience.

Even an electricity outage occurs during the operation of the electric curtain 3, a furling of the covering sheet 311 would be firstly proceeded after the power supply is resumed so as to allow the actuating member 333 moving relative to the sensor 334. Namely, the rolling shaft 31 would furl the covering sheet 311 back to the upper limit position a, and the processing unit 342 would retrieve the counter 335 by zeroing while aligning the actuating member 333 with the sensor 334, so that the electric curtain 3 appropriately restarts operating and efficiently conduces to a using convenience.

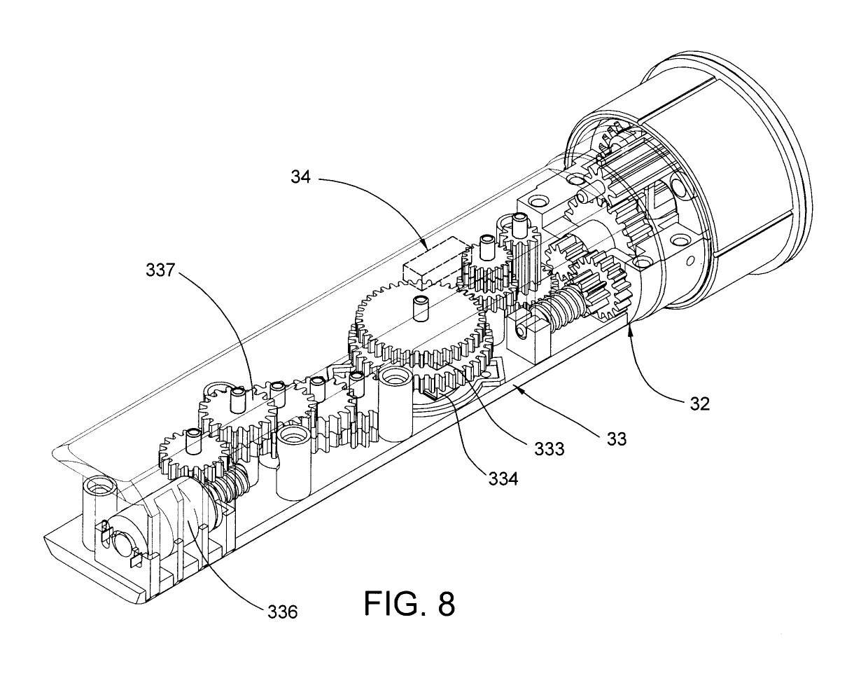

Referring to FIG. 8, a second preferred embodiment of the present invention comprises elements, operations and functions similar to the first preferred embodiment, in which the electric curtain 3 still comprises a rail 30, a rolling shaft 31, a power 32, a zero device 33, and a controlling device 34. Differentially, an adjusting member 336 is disposed at one side of the zero device 33 for preferably adjusting the position of the sensor 334. Further, a governor 337 can be alternatively installed between the adjusting member 336 and the zero device 33 for controlling the output power of the adjusting member 336. Accordingly, by means of the additive adjustment member 336 cooperating with the governor 337, the position of the sensor 334 can be more delicately amended to collaborate with the actuating member 333 for achieving the merits of precisely controlling the covering sheet at the desired position, obtaining an efficient speedy adjustment, and attaining a convenient operation.

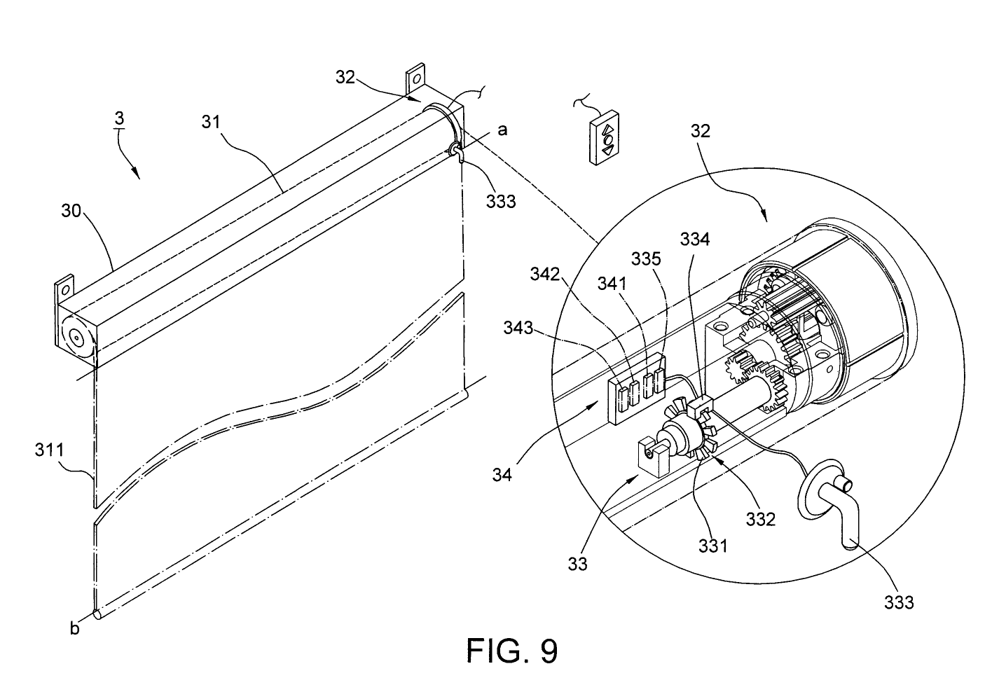

Referring to FIG. 9, a third preferred embodiment of the present invention comprises elements, operations and functions similar to the first preferred embodiment, in which the electric curtain 3 still comprises a rail 30, a rolling shaft 31, a power 32, a zero device 33, and a controlling device 34. Specifically, the arrangement of the interrelated elements in the zero device 33 can be either performed in the configuration like the first and second preferred embodiments or performed in the configuration like this embodiment. Namely, the actuating member 333 of the zero device 33 in this embodiment is set as a discrete part to separate from the turning member 331 on which a plurality of apertures 332 are equidistantly defined, and the sensor 334 is still correspondingly situated with respect to the turning member 331. Accordingly, when the turning member 331 and the rolling shaft 31 are concurrently rotated, the sensor 334 would be able to sense the rotation of the turning member 331, and the actuating member 333 would be triggered by the furling of the covering sheet 311 stopping at the upper limit position a.

Further in setting, the covering sheet 311 is firstly dropped to the lower limit position b for the sensor 334 to simultaneously sense the relative rotation of the turning member 331, enhancing the counter 335 to convert the rotation into a data for the memory unit 343 to save as a standard data basis serving for the succeeding dropping basis of the covering sheet 311. In the succeeding operation for dropping the covering sheet 311, the processing unit 342 would thence impede the power 32 from operating and stop the covering sheet 311 at a proper position when the rotating number of the turning member 331 counted by the counter 335 equals to the standard data basis saved in the memory unit 343. In contrast, when the covering sheet 311 is retracted or furled to the upper limit position a, the covering sheet 311 propels the actuating member 333 for the sensor 334 to directly emit a signal; whereby, the receiver 341 receives the signal from the sensor 334, and the processing unit 342 accordingly impedes the driving of the power 32 and concomitantly resumes the counting of the counter 335 to zero. Therefore, the counter 335 recounts when every time the covering sheet 311 is dropped.

To sum up, the present invention takes advantages of the actuating member of the zero device cooperating with the correlated sensor. Thereby, the covering sheet furled to the upper limit position would force the sensor to emit a signal to the controlling device for stopping the power and returning the counting of the counter to zero, which benefits a newly counting in pursuance of a next descent of the covering sheet. Thus, the present invention decreases an accumulative error resulting from inaccurate movements of the covering sheet after using for a long time for ensuring a precise suspension of the covering sheet and promoting an operative convenience.

Various modifications may be made in further embodiments described without departing from the spirit and scope of the invention.

I claim:

1. An electric curtain via accurately controlling a stop position of its covering sheet comprising:
a rail;
a rolling shaft pivoted on said rail, including a covering sheet rolled by said rolling shaft; wherein, said stop position of said covering sheet being divided into an upper limit position and a lower limit position;
a power disposed on said rail for driving said rolling shaft;
a zero device situated by one side of said power, including a turning member concurrently turned with said rolling shaft, an actuating member disposed correspondingly to said turning member, a sensor relatively positioned with said actuating member, and a counter connected to said sensor; and
a controlling device respectively connected to said zero device and said power, including a receiver connected to said sensor, a processing unit respectively connected to said receiver and said power, and a memory unit connected to said processing unit; wherein, said covering sheet stopped at said upper limit position triggering said actuating member for said sensor to generate a signal and to transmit said signal to said processing unit so as to stop said power and control returning said counter to zero.

2. The electric curtain as claimed in claim 1, wherein, said actuating member is installed on said turning member, and said actuating member preferably aligns with said sensor in time of stopping said covering sheet at said upper limit position.

3. The electric curtain as claimed in claim 1, wherein, said actuating member is disposed separately from said turning member and triggered via stopping said covering sheet at said upper limit position.

4. The electric curtain as claimed in claim 3, wherein, a plurality of apertures are equidistantly defined on said turning member for said sensor to sense rotable displacements of said apertures.

5. The electric curtain as claimed in claim 1, wherein, an adjusting member is disposed at one side of said sensor for adjusting a proper position of said sensor.

6. The electric curtain as claimed in claim 5, wherein, a governor is mounted between said adjusting member and said zero device for regulating an output force of said adjusting member.
